(19) United States
(12) Patent Application Publication
(10) Pub. No.: US 2013/0072538 A1
(43) Pub. Date: Mar. 21, 2013

(54) USE OF TETRAMIC ACID DERIVATIVES FOR INSECT CONTROL

(71) Applicant: BAYER CROPSCIENCE AG, Monheim (DE)

(72) Inventors: Reiner FISCHER, Monheim (DE); Ernst BRUECK, Bergisch Gladbach (DE); Xavier Alain Marie VAN WAETERMEULEN, Dusseldorf (DE)

(73) Assignee: BAYER CROPSCIENCE AG, Monheim (DE)

(21) Appl. No.: 13/676,818

(22) Filed: Nov. 14, 2012

Related U.S. Application Data
(62) Division of application No. 12/299,953, filed on Apr. 6, 2009.

(30) Foreign Application Priority Data
May 12, 2006 (DE) 10 2006 022 821.9

(51) Int. Cl. A01N 43/38

(52) U.S. Cl. CPC A01N 43/38
USPC 514/409

(57) ABSTRACT

The present invention relates to the use of compounds of the formula (I)

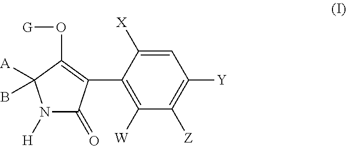

for controlling insects from the order beetles (Coleoptera), thrips (Tysanoptera), bugs (Hemiptera), flies (Diptera), leafhoppers (Auchenorrhyncha) and the families gall midges (Cecidomyiidae), leaf miners (Gracillariidae), tortrix moths (Tortricidae) and sawflies (Tenthredinidae) in which A, B, G, W, X, Y and Z have the abovementioned meanings.

This application is a Divisional Application of U.S. application Ser. No. 12/299,953 filed Apr. 6, 2009, which is a §371 National Stage Application of PCT/EP2007/004093 filed May 9, 2007, which claims priority to German Application 10 2006 022 821.9 filed May 12, 2006, each hereby incorporated by reference in their entireties.

The present invention relates to the use of tetramic acid derivatives for controlling insects from the order beetles (Coleoptera), thrips (Tysanoptera), bugs (Hemiptera), flies (Diptera), leafhoppers (Auchenorrhyncha) and the families gall midges (Cecidomyiidae), leaf miners (Gracillariidae), tortrix moths (Tortricidae) and sawflies (Tenthredinidae).

The tetramic acid derivatives are known from EP-A-456 063, EP-A-521 334, EP-A-596 298, EP-A-613 884, WO 95/01 997, WO 95/26 954, WO 95/20 572, EP-A-0 668 267, WO 96/25 395, WO 96/35 664, WO 97/01 535, WO 97/02 243, WO 97/36 868, WO 97/43 275, WO 98/05638, WO 98/06721, WO 98/25928, WO 99/16748, WO 99/24437, WO 99/43649, WO 99/48869 and WO 99/55673, WO 01/09092, WO 01/17972, WO 01/23354, WO 01/74770, WO 03/013249, WO 2004/007 448, WO 2004/024 688, WO 04/065 366, WO 04/080 962, WO 04/111 042, WO 05/044 791, WO 05/044 796, WO 05/048 710, WO 05/049 596, WO 05/066 125, WO 05/092 897, WO 06/000 355, WO 06/029799, WO 06/056281, WO 06/056282, WO 06/089633.

The insecticidal activity of some of these compounds against insects from the suborder Sternorhyncha is known (WO 06/077071). The activity against the mustard beetle Phaedon cochlearie on cabbage has also been described. Furthermore described is the activity against the green rice leafhopper Nephotettix cinticeps in rice.

Surprisingly, it has now been found that tetramic acid derivatives are also highly suitable for controlling further animal pests from the suborders Heteroptera, Terebrantia, Nematocera and Brachycera.

It has furthermore also been found that tetramic acid derivatives are also highly effective against Cicadellidae in dicotyledonous crops such as vegetables, cotton, potatoes, and, surprisingly, also in perennial crops such as tropical fruits, conifers, grapevines, tea and ornamentals.

Furthermore, it has been found that tetramic acid derivatives are also very effective against true weevils (Curculionidae) and leaf beetles (Chrysomelidae) in further annual crops such as potatoes, tobacco, melons, beet, oilseed rape, cereals, fruit vegetables, tuber vegetables, leaf vegetables, root vegetables, stem vegetables, bulb vegetables, inflorescences as vegetables and, surprisingly, also in perennial crops such as, for example, citrus, pome and stone fruit, nuts, almonds, soft fruit, grapevines and hops, and tropical crops, ornamentals, cottons and spices.

Likewise, it has been found that tetramic acid derivatives are also highly effective against tortrix moths (Tortricidae) and leaf miners (Gracillariidae) in perennial crops such as, for example, stone and pome fruit and citrus.

In addition, it has been found that tetramic acid derivatives are also highly effective against gall midges (Cecidomyiidae) in perennial crops such as, for example, citrus, pome fruit, but also in vegetables and cereals.

Also, it has been found that tetramic acid derivatives are highly effective against sawflies (Tenthredinidae) in perennial crops such as, for example, pome fruit, stone fruit and in afforestations.

Accordingly, the present invention relates to the use of tetramic acid derivatives for controlling insects from the families a) stink bugs (Pentatomidae), plant bugs (Miridae), thrips (Thripidae), leaf miners (Agromyzidae), gall midges (Cecidomyiidae), fruitflies (Tephritidae) and root-maggot flies (Anthomyiidae) in annual and perennial and also tropical crops, and b) for controlling pests from the family Cicadellidae in dicotyledonous crops, and annual and perennial crops and in tropical crops and c) for controlling insects from the family leaf beetles (Chrysomelidae) and true weevils (Curculionidae) in annual crops such as potatoes, tobacco, melons, beet, oilseed rape, cereals, fruit vegetables, tuber vegetables, leaf vegetables, root vegetables, stem vegetables, bulb vegetables, inflorescences as vegetables and, surprisingly, also in perennial crops such as, for example, citrus, pome and stone fruit, nuts, almonds, soft fruit, grapevines and hops and tropical crops, ornamentals, cotton and spices, d) for controlling pests from the family tortrix moths (Tortricidae) and leaf miners (Gracillariidae) in perennial crops such as, for example, citrus, stone and pome fruit and conifers, e) for controlling gall midges (Cecidomyiidae) in annual crops such as, for example, vegetables, cereals, potatoes and perennial crops such as, for example, citrus, pome fruit, conifers and afforestations, f) for controlling sawflies (Tenthredinidae), for example in pome fruit, stone fruit, afforestations.

The crops to be protected which have only been described in general terms will be described in greater detail and specified hereinbelow. Thus, as regards the use, vegetables are understood as meaning for example fruiting vegetables and inflorescences as vegetables, for example bell peppers, chillies, tomatoes, aubergines, cucumbers, pumpkins, courgettes, broad beans, climbing and dwarf beans, peas, artichokes, maize;

but also leafy vegetables, for example head-forming lettuce, chicory, endives, various types of cress, of rocket, lamb's lettuce, iceberg lettuce, leeks, spinach, Swiss chard;

furthermore tuber vegetables, root vegetables and stem vegetables, for example celeriac/celery, beetroot, carrots, radish, horseradish, scorzonera, asparagus, beet for human consumption, palm hearts, bamboo shoots, furthermore bulb vegetables, for example onions, leeks, Florence fennel, garlic;

furthermore Brassica vegetables such as cauliflower, broccoli, kohlrabi, red cabbage, white cabbage, curly kale, Savoy cabbage, Brussels sprouts, Chinese cabbage.

With regard to the use in cereal crops, this is understood as meaning, for example, wheat, barley, rye, oats, triticale, but also maize, millet/sorghum and rice;

regarding the use in fruit or perennial crops, this is understood as meaning citrus, such as, for example, oranges, grapefruits, tangerines, lemons, limes, Seville oranges, kumquats, satsumas;

but also pome fruit such as, for example, apples, pears and quinces, and stone fruit such as, for example, peaches, nectarines, cherries, plums, quetsch, apricots;

furthermore grapevines, hops, olives, tea and tropical crops such as, for example, mangoes, papayas, figs, pineapples, dates, bananas, durians, kaki fruit, coconuts, cacao, coffee, avocados lychees, maracujas, guavas,

moreover almonds and nuts such as, for example, hazelnuts, walnuts, pistachios, cashew nuts, para nuts, pecan nuts, butternuts, chestnuts, hickory nuts, macadamia nuts, peanuts, moreover also soft fruit such as, for example, currants, gooseberries, raspberries, blackberries, blueberries, strawberries, cranberries, including American cranberries, kiwi fruit.

As regards the use, ornamentals are understood as meaning annual and perennial plants, for example cut flowers such as, for example, roses, carnations, gerbera, lilies, marguerites, chrysanthemums, tulips, narcissus, anemones, poppies, amaryllis, dahlias, azaleas, hibiscus,

but also for example border plants, pot plants and perennials such as, for example, roses, Tagetes, violas, geraniums, fuchsias, hibiscus, chrysanthemum, busy lizzie, cyclamen, African violet, sunflowers, begonias,

furthermore for example bushes and conifers such as, for example, ficus, rhododendron, firs, spruces, pines, including umbrella pines, yews, juniper, oleander.

As regards the use in spices, these are understood as meaning annual and perennial plants such as, for example, aniseed, chilli pepper, paprika, pepper, vanilla, marjoram, thyme, cloves, juniper berries, cinnamon, tarragon, coriander, saffron, ginger.

The tetramic acid derivatives are compounds of the formula (I)

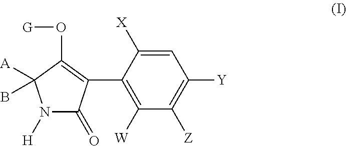

in which
X represents halogen, alkyl, alkoxy, haloalkyl, haloalkoxy or cyano,
W, Y and Z independently of each other represent hydrogen, halogen, alkyl, alkoxy, haloalkyl, haloalkoxy or cyano,
A represents hydrogen, or represents in each case optionally halogen-substituted alkyl, alkoxyalkyl, saturated, optionally substituted cycloalkyl in which optionally at least one ring atom is replaced by a hetero atom,
B represents hydrogen or alkyl,
   or
A and B together with the carbon atom to which they are bonded represent a saturated or unsaturated, unsubstituted or substituted cycle which optionally contains at least one hetero atom,
G represents hydrogen (a) or one of the groups

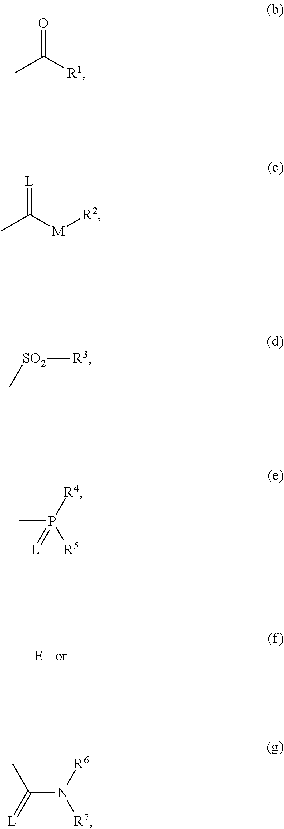

in which
E represent a metal ion or an ammonium ion,
L represents oxygen or sulphur,
M represents oxygen or sulphur,
R¹ represents in each case optionally halogen-substituted alkyl, alkenyl, alkoxyalkyl, alkylthioalkyl, polyalkoxyalkyl or optionally halogen-, alkyl- or alkoxy-substituted cycloalkyl which can be interrupted by at least one hetero atom, in each case optionally substituted phenyl, phenylalkyl, hetaryl, phenoxyalkyl or hetaryloxyalkyl,
R² represents in each case optionally halogen-substituted alkyl, alkenyl, alkoxyalkyl, polyalkoxyalkyl or in each case optionally substituted cycloalkyl, phenyl or benzyl,
R³ represents optionally halogen-substituted alkyl or optionally substituted phenyl,
R⁴ and R⁵ independently of one another represent in each case optionally halogen-substituted alkyl, alkoxy, alkylamino, dialkylamino, alkylthio, alkenylthio, cycloalkylthio, or represent in each case optionally substituted phenyl, benzyl, phenoxy or phenylthio, and
R⁶ and R⁷ independently of one another represent hydrogen, in each case optionally halogen-substituted alkyl, cycloalkyl, alkenyl, alkoxy, alkoxyalkyl, optionally substituted phenyl, optionally substituted benzyl or, together with the N atom to which they are bonded, represent an optionally substituted ring which is optionally interrupted by oxygen or sulphur,
in the form of their isomer mixtures or their pure isomers.

Tetramic acid derivatives of the abovementioned formula (I) which can preferably be employed are those in which the radicals have the following meanings:
W preferably represents hydrogen, C₁-C₄-alkyl, C₁-C₄-alkoxy, chlorine, bromine or fluorine,
X preferably represents C₁-C₄-alkyl, C₁-C₄-alkoxy, C₁-C₄-haloalkyl, fluorine, chlorine or bromine,
Y and Z independently of one another preferably represent hydrogen, C₁-C₄-alkyl, halogen, C₁-C₄-alkoxy or C₁-C₄-haloalkyl,
A preferably represents hydrogen or in each case optionally halogen-substituted C₁-C₆-alkyl or C₃-C₈-cycloalkyl,
B preferably represents hydrogen, methyl or ethyl,
A, B and the carbon atom to which they are bonded preferably represent saturated C₃-C₆-cycloalkyl in which one ring member is optionally replaced by oxygen or sulphur and which is optionally monosubstituted or disubstituted by C₁-C₄-alkyl, trifluoromethyl or C₁-C₄-alkoxy,
G preferably represents hydrogen (a) or one of the groups

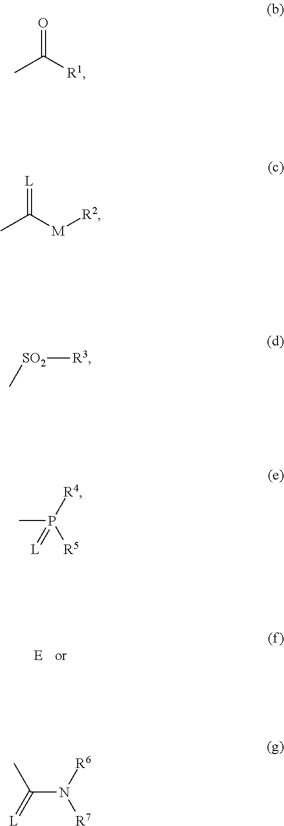

in particular (a), (b), (c) or (g)
in which
E represents a metal ion or an ammonium ion,
L represents oxygen or sulphur and
M represents oxygen or sulphur,
R¹ preferably represents in each case optionally halogen-substituted C₁-C₁₀-alkyl, C₂-C₁₀-alkenyl, C₁-C₄-alkoxy-C₁-C₄-alkyl, C₁-C₄-alkylthio-C₁-C₄-alkyl, or represents C₃-C₆-cycloalkyl which is optionally substituted by fluorine, chlorine, C₁-C₄-alkyl or C₁-C₂-alkoxy,
   or represents phenyl which is optionally substituted by fluorine, chlorine, bromine, cyano, nitro, C₁-C₄-alkyl, C₁-C₄-alkoxy, trifluoromethyl or trifluoromethoxy,
   or represents pyridyl or thienyl, each of which is optionally substituted by chlorine or methyl,
R² preferably represents in each case fluorine- or chlorine-substituted C₁-C₁₀-alkyl, C₂-C₁₀-alkenyl, C₁-C₄-alkoxy-C₂-C₄-alkyl,
   or represents optionally methyl- or methoxy-substituted C₅-C₆-cycloalkyl, or
   represents phenyl or benzyl, each of which is optionally substituted by fluorine, chlorine, bromine, cyano, nitro, C₁-C₄-alkyl, C₁-C₄-alkoxy, trifluoromethyl or trifluoromethoxy,
R³ preferably represents optionally fluorine-substituted C₁-C₄-alkyl, or represents phenyl which is optionally substituted by fluorine, chlorine, bromine, C₁-C₄-alkyl, C₁-C₄-alkoxy, trifluoromethyl, trifluoromethoxy, cyano or nitro,
R⁴ preferably represents in each case optionally fluorine- or chlorine-substituted C₁-C₄-alkyl, C₁-C₄-alkoxy, C₁-C₄-alkylamino, C₁-C₄-alkylthio or represents phenyl, phenoxy or phenylthio, each of which is optionally substituted by fluorine, chlorine, bromine, nitro, cyano, C₁-C₄-alkoxy, trifluoromethoxy, C₁-C₄-alkylthio, C₁-C₄-haloalkylthio, C₁-C₄-alkyl or trifluoromethyl,
R⁵ preferably represents C₁-C₄-alkoxy or C₁-C₄-thioalkyl,
R⁶ preferably represents C₁-C₆-alkyl, C₃-C₆-cycloalkyl, C₁-C₆-alkoxy, C₃-C₆-alkenyl or C₁-C₄-alkoxy-C₁-C₄-alkyl,
R⁷ preferably represents C₁-C₆-alkyl, C₃-C₆-alkenyl or C₁-C₄-alkoxy-C₁-C₄-alkyl,
R⁶ and R⁷ together preferably represent an optionally methyl- or ethyl-substituted C₃-C₆-alkylene radical in which one carbon atom is optionally replaced by oxygen or sulphur,
   in the form of their isomer mixtures or their pure isomers.

Tetramic acid derivatives of the abovementioned formula (I) which can especially preferably be employed are those in which the radicals have the following meanings:
W especially preferably represents hydrogen, methyl, ethyl, chlorine, bromine or methoxy,
X especially preferably represents chlorine, bromine, methyl, ethyl, propyl, i-propyl, methoxy, ethoxy or trifluoromethyl,
Y and Z especially preferably independently of one another represent hydrogen, fluorine, chlorine, bromine, methyl, ethyl, propyl, i-propyl, trifluoromethyl or methoxy,
A especially preferably represents methyl, ethyl, propyl, i-propyl, butyl, i-butyl, sec-butyl, tert-butyl, cyclopropyl, cyclopentyl or cyclohexyl,
B especially preferably represents hydrogen, methyl or ethyl,
   or
A, B and the carbon atom to which they are bonded especially preferably represent saturated C₆-cycloalkyl in which one ring member is optionally replaced by oxygen and which is optionally monosubstituted by methyl, ethyl, trifluoromethyl, methoxy, ethoxy, propoxy or butoxy,
G especially preferably represents hydrogen (a) or one of the groups

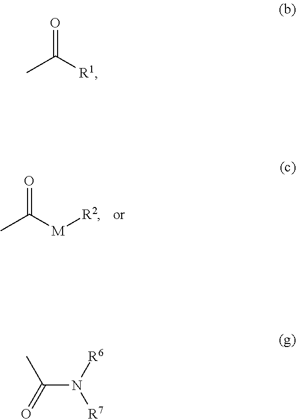

in which
M represents oxygen or sulphur,
R¹ especially preferably represents C₁-C₈-alkyl, C₂-C₄-alkenyl, methoxymethyl, ethoxymethyl, ethylthiomethyl, cyclopropyl, cyclopentyl or cyclohexyl,
   or represents phenyl which is optionally monosubstituted to disubstituted by fluorine, chlorine, bromine, cyano, nitro, methyl, ethyl, methoxy, trifluoromethyl or trifluoromethoxy,
   or represents pyridyl or thienyl, each of which is optionally substituted by chlorine or methyl,
R² especially preferably represents C₁-C₈-alkyl, C₂-C₄-alkenyl, methoxyethyl, ethoxyethyl, or represents phenyl or benzyl,
R⁶ and R⁷ independently of one another especially preferably represent methyl or ethyl or together represent a Cₛ-alkylene radical in which the C₃-methylene group is replaced by oxygen,
   in the form of their isomer mixtures or their pure isomers.

Tetramic acid derivatives of the abovementioned formula (I) which can very especially preferably be employed are those in which the radicals have the following meanings:
W very especially preferably represents hydrogen or methyl,
X very especially preferably represents chlorine, bromine or methyl,
Y and Z independently of one another very especially preferably represent hydrogen, chlorine, bromine or methyl,
A, B and the carbon atom to which they are bonded very especially preferably represent saturated C₆₋cycloalkyl in which one ring member is optionally replaced by oxygen and which is optionally monosubstituted by methyl, trifluoromethyl, methoxy, ethoxy, propoxy or butoxy,
G very especially preferably represents hydrogen (a) or one of the groups

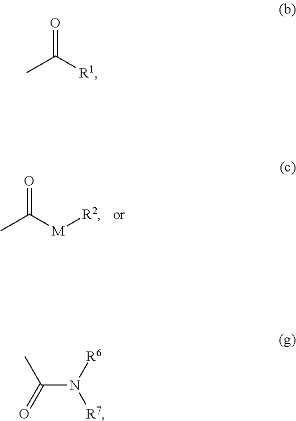

in which
M represents oxygen or sulphur,
R¹ very especially preferably represents C₁-C₈-alkyl, C₂-C₄-alkenyl, methoxymethyl, ethoxymethyl, ethylthiomethyl, cyclopropyl, cyclopentyl, cyclohexyl or
   represents phenyl which is optionally monosubstituted by fluorine, chlorine, bromine, methyl, methoxy, trifluoromethyl, trifluoromethoxy, cyano or nitro,
   or represents pyridyl or thienyl, each of which is optionally substituted by chlorine or methyl,
R² very especially preferably represents C₁-C₈-alkyl, C₂-C₄-alkenyl, methoxyethyl, ethoxyethyl, phenyl or benzyl,
R⁶ and R⁷ independently of one another very especially preferably represent methyl or ethyl or together represent a C₅-alkylene radical in which the C₃-methylene group is replaced by oxygen
   in the form of their isomer mixtures or their pure isomers.

Tetramic acid derivatives of the abovementioned formula (I) which can preferably be employed in particular are those in which the radicals have the following meanings:

(I)

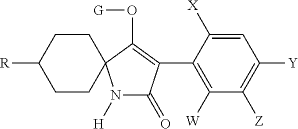

| Example | | | | | | | |
|---|---|---|---|---|---|---|---|
| No. | W | X | Y | Z | R | G | M.p. ° C. |
| I-1 | H | Br | H | CH₃ | OCH₃ | CO-i-C₃H₇ | 122 |
| I-2 | H | Br | H | CH₃ | OCH₃ | CO₂—C₂H₅ | 140-142 |
| I-3 | H | CH₃ | H | CH₃ | OCH₃ | H | >220 |
| I-4 | H | CH₃ | H | CH₃ | OCH₃ | CO₂—C₂H₅ | 128 |
| I-5 | CH₃ | CH₃ | H | Br | OCH₃ | H | >220 |
| I-6 | CH₃ | CH₃ | H | Cl | OCH₃ | H | 219 |
| I-7 | H | Br | CH₃ | CH₃ | OCH₃ | CO-i-C₃H₇ | 217 |
| I-8 | H | CH₃ | Cl | CH₃ | OCH₃ | CO₂C₂H₅ | 162 |
| I-9 | CH₃ | CH₃ | CH₃ | CH₃ | OCH₃ | H | >220 |
| I-10 | CH₃ | CH₃ | H | Br | OC₂H₅ | CO-i-C₃H₇ | 212-214 |
| I-11 | H | CH₃ | CH₃ | CH₃ | OC₂H₅ | CO-n-C₃H₇ | 134 |
| I-12 | H | CH₃ | CH₃ | CH₃ | OC₂H₅ | CO-i-C₃H₇ | 108 |
| I-13 | H | CH₃ | CH₃ | CH₃ | OC₂H₅ | CO-c-C₃H₅ | 163 |

in the form of their cis/trans isomer mixtures or their pure cis isomers.

The compounds of the formula (I) are known compounds whose preparation has been described in the patents/patent applications which have been cited at the outset (see especially WO 97/01535, WO 97/36868 and WO 98/05 638).

Compounds which are emphasized are the compounds (1-3) and (1-4), which are disclosed in WO 04/007448.

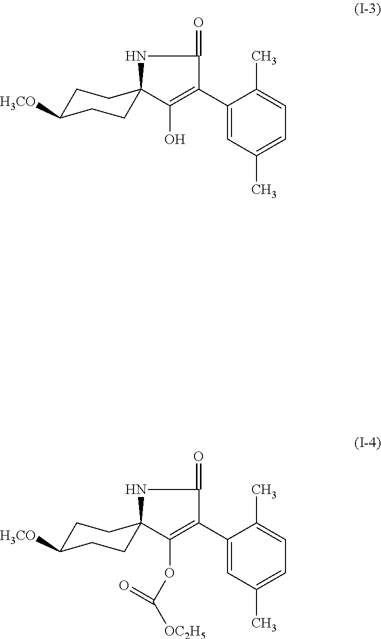

Preferred from the stink bug family (Pentatomidae) are: Antestiopsis spp., Dichelops spp., Eurygaster spp., Euschistus spp., Nezara spp., Obealus spp., Piezodorus spp. and Scothinophora spp. in crops such as, for example, fruit, vegetables, beet, cereals, rice, maize and soybeans.

Preferred from the plant bug family (Miridae) are: Collaria spp., Calocoris spp., Heliopeltis spp., Horcias spp., Lygus spp. and Psallus spp. in crops such as, for example, fruit, nuts, potatoes, vegetables, in tropical crops, cotton, ornamentals, tea, soft fruit and soybeans.

Preferred from the thrips family (Thripidae) are: Anaphothrips spp., Baliothrips spp., Caliothrips spp., Frankliniella spp., Heliothrips spp., Hercinothrips spp., Rhipiphorothrips spp., Scirtothrips spp., Selenothrips spp. and Thrips spp., in crops such as, for example, fruit, cotton, grapevines, tea, rice, nuts, tropical crops, ornamentals, conifers, tobacco, spices, vegetables, soft fruit, melons, citrus, potatoes and beet.

Preferred from the leaf miner (Agromyzidae) and root-maggot fly families (Anthomyiidae) are: Agromyza spp., Amauromyza spp., Atherigona spp., Chlorops spp., Liriomyza spp., Oscinella spp., Pegomyia spp. in crops such as, for example, vegetables, melons, cereals, maize, potatoes, beet, nuts, ornamentals.

Preferred from the Cicadellidae family are: Circulifer spp., Dalbus spp., Empoasca spp., Erythroneura spp., Homalodisca spp., Iodioscopus spp., Oncometopia spp., in crops such as, for example, citrus, fruit, grapevines, potatoes, vegetables, ornamentals, conifers, melons, cotton, soft fruit, tea, nuts and tropical crops.

Furthermore preferred are the following from the true weevil family (Curculionidae): Anthonomus spp., Apion spp., Bothynoderes spp., Ceutorhynchus spp., Cleonus spp., Contrachelus spp., Cosmopolites spp., Curculio spp., Hypera spp., Lissorphoptrus spp., Lixus spp., Premnotrypes spp., Sternechus spp., Tanymecus spp. in crops such as, for example, vegetables, potatoes, fruit, ornamentals, cotton, oilseed rape, beet, soybeans and nuts.

Furthermore preferred are the following from the leaf beetle family (Chrysomelidae):

| | |
|---|---|
| Aulacophora spp. | in melons, vegetables, potatoes, beet, oilseed rape, |
| | ornamentals, soft fruit, |
| Cassida spp. | in beet, |
| Lema spp. | in cereals, rice, |
| Leptinotarsa spp. | in potatoes, vegetables, |
| Haltica spp. | in grapevines, |
| Phyllotreta spp. | in vegetables and oilseed rape. |

Preferred are the following from the tortrix moth family (Tortricidae):

Adoxophyes spp., Cocoecia spp., Carpocapsa spp., Clysia spp., Acleris spp., Argyrotaenia spp., Homona spp., Laspeyresia spp., Lobesia spp., Pandemis spp., Polychrosis spp. in crops such as pome and stone fruit, vegetables, conifers, nuts, grapevines, ornamentals.

The following are preferred from the leaf miner family (Gracillariidae):

Caloptilia spp., Gracillaria spp., Lithocolletis spp., Leucoptera spp., Phtorimaea spp., Phylloenistis spp. in crops such as pome fruit, stone fruit, grapevines, nuts, citrus, conifers, potatoes, coffee.

The following are preferred from the gall midge family (Cecodomyiidae):

Contarinia spp., Dasineura spp., Diplosis spp. in crops such as citrus, pome fruit, stone fruit, vegetables, cereals, potatoes, alfalfa, cotton, spices, soft fruit.

The following are preferred from the sawfly family (Tenthredinidae): Hoplocampa spp., Cephalcia spp., Nematus spp., Caliroa spp., Macrophyra spp. in crops such as pome fruit, stone fruit, ornamentals, afforestations.

All plants and plant parts can be treated in accordance with the invention. In this context, plants are understood as meaning all plants and plant populations such as desired and undesired wild plants or crop plants (including naturally occurring crop plants). Crop plants can be plants which can be obtained by traditional breeding and optimization methods or by biotechnological and recombinant methods, or combinations of these methods, including the transgenic plants and including the plant varieties which are capable or not capable of being protected by Plant Breeders' Rights. Plant parts are understood as meaning all aerial and subterranean parts and organs of the plants such as shoot, leaf, flower and root, examples which may be mentioned being leaves, needles, stalks, stems, flowers, fruit bodies, fruits and seeds, but also roots, tubers and rhizomes. The plant parts also include crop material and vegetative and generative propagation material, for example cuttings, tubers, rhizomes, slips and seeds.

The treatment according to the invention with the active compound, of the plants and plant parts, is effected directly or by treating their environment, habitat or store using conventional treatment methods, for example by dipping, spraying, fumigating, fogging, scattering, brushing on, injecting, and, in the case of propagation material, in particular seeds, furthermore by coating with one or more coats.

As already mentioned above, all plants and their parts can be treated in accordance with the invention. In a preferred embodiment, plant species and plant varieties which are found in the wild or which are obtained by traditional biological breeding methods, such as hybridization or protoplast fusion, and parts of these species and varieties are treated. In a further preferred embodiment, transgenic plants and plant varieties which have been obtained by recombinant methods, if appropriate in combination with traditional methods (genetically modified organisms) and their parts are treated. The term “parts”, “parts of plants” or “plant parts” have been described above.

Plants which are especially preferably treated in accordance with the invention are those of the varieties which are in each case commercially available or in use. Plant varieties are understood as meaning plants with novel traits which have been bred both by conventional breeding, by mutagenesis or by recombinant DNA techniques. They may take the form of varieties, biotypes or genotypes.

Depending on the plant species or plant varieties, their location and growth conditions (soils, climate, vegetation period, nutrition), superadditive (“synergistic”) effects may also occur as a result of the treatment according to the invention. Effects which exceed the effects actually to be expected are, for example, reduced application rates and/or widened activity spectrum and/or an enhancement of the activity of the substances and compositions which can be used in accordance with the invention, better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processability of the crop products.

The preferred transgenic plants or plant varieties (plants or plant varieties obtained by means of genetic engineering) which are to be treated in accordance with the invention include all plants which, by means of the recombinant modification, have received genetic material which confers particularly advantageous valuable traits to these plants. Examples of such traits are better plant growth, increased tolerance to high or low temperatures, increased tolerance to drought or to water or soil salinity, increased flowering performance, facilitated harvest, speedier maturation, higher yields, higher quality and/or higher nutritional value of the crop products, better storability and/or processability of the crop products. Other examples of such traits which are particularly emphasized are an improved defence of the plants against animal and microbial pests such as insects, mites, phytopathogenic fungi, bacteria and/or viruses, and an increased tolerance of the plants to specific herbicidal active compounds. Examples of transgenic plants which are mentioned are the important crop plants such as cereals (wheat, rice), maize, soybean, potato, cotton, tobacco, oilseed rape and fruit plants (with the fruits apples, pears, citrus fruits and grapes), with particular emphasis on maize, soybean, potatoes, cotton, tobacco and oilseed rape. Traits which are particularly emphasized are the increased defence of the plants against insects, arachnids, nematodes and slugs and snails as the result of toxins formed in the plants, in particular toxins which are produced in the plants by the genetic material of Bacillus thuringiensis (for example by the genes CryIA(a), CryIA(b), CryIA(c), CryIIA, CryIIIA, CryIIIB2, Cry9c, Cry2Ab, Cry3Bb and CryIF and their combinations) (hereinbelow “Bt plants”). Traits which are also particularly emphasized are the increased defence of plants against fungi, bacteria and viruses by systemic acquired resistance (SAR), systemin, phytoalexins, elicitors and resistance genes and correspondingly expressed proteins and toxins. Traits which are furthermore especially emphasized are the increased tolerance of the plants to specific herbicidal active compounds, for example imidazolinones, sulphonylureas, glyphosate or phosphinothricin (for example “PAT” gene). The specific genes which confer the desired traits can also occur in combinations with one another in the transgenic plants. Examples of “Bt plants” which may be mentioned are maize varieties, cotton varieties, soybean varieties and potato varieties sold under the trade names YIELD GARD® (for example maize, cotton, soybean), KnockOut® (for example maize), StarLink® (for example maize), Bollgard® (cotton), Nucotn® (cotton) and NewLeaf® (potato). Examples of herbicide-tolerant plants which may be mentioned are maize varieties, cotton varieties and soybean varieties which are sold under the trade names Roundup Ready® (glyphosate tolerance, for example maize, cotton, soybean), Liberty Link® (phosphinothricin tolerance, for example oilseed rape), IMI® (imidazolinone tolerance) and STS® (sulphonylurea tolerance, for example maize). Herbicide-resistant plants (bred conventionally for herbicide tolerance) which may also be mentioned are the varieties sold under the name Clearfield® (for example maize). Naturally, what has been said also applies to plant varieties which will be developed, or marketed, in the future and which have these genetic traits or traits to be developed in the future.

The active compound of the formula (I) can be converted into the customary formulations, such as solutions, emulsions, wettable powders, suspensions, powders, dusts, pastes, soluble powders, granules, suspoemulsion concentrates, natural and synthetic materials impregnated with active compound, and ultrafine encapsulations in polymeric materials.

These formulations are produced in the known manner, for example by mixing the active compound with extenders, that is, liquid solvents and/or solid carriers, optionally with the use of surfactants, that is, emulsifiers and/or dispersants and/or foam formers.

Suitable extenders are, for example, water, polar and unpolar organic chemical liquids, for example from the classes of the aromatic and nonaromatic hydrocarbons (such as paraffins, alkylbenzenes, alkylnaphthalenes, chlorobenzenes), of the alcohols and polyols (which can optionally also be substituted, etherified and/or esterified), of the ketones (such as acetone, cyclohexanone), esters (including fats and oils) and (poly)ethers, of the unsubstituted and substituted amines, amides, lactams (as N-alkylpyrrolidones) and lactones, the sulphones and sulphoxides (such as dimethyl sulphoxide).

In the case of the use of water as an extender, organic solvents can, for example, also be used as cosolvents. Liquid solvents which are suitable are mainly: aromatics, such as xylene, toluene or alkylnaphthalenes, chlorinated aromatics or chlorinated aliphatic hydrocarbons, such as chlorobenzenes, chloroethylenes or methylene chloride, aliphatic hydrocarbons, such as cyclohexane or paraffins, for example mineral oil fractions, mineral oils and vegetable oils, alcohols, such as butanol or glycol as well as their ethers and esters, ketones, such as acetone, methyl ethyl ketone, methyl isobutyl ketone or cyclohexanone, strongly polar solvents, such as dimethylformamide and dimethyl sulphoxide, and water.

Solid carriers which are suitable are:

for example ammonium salts and ground natural minerals, such as kaolins, clays, talc, chalk, quartz, attapulgite, montmorillonite or diatomaceous earth, and ground synthetic minerals, such as highly-disperse silica, alumina and silicates; suitable solid carriers for granules are: for example crushed and fractionated natural rocks such as calcite, marble, pumice, sepiolite and dolomite, and synthetic granules of inorganic and organic meals, and granules of organic material such as sawdust, coconut shells, maize cobs and tobacco stalks; suitable emulsifiers and/or foam formers are: for example non-ionic and anionic emulsifiers, such as polyoxyethylene fatty acid esters, polyoxyethylene fatty alcohol ethers, for example alkylaryl polyglycol ethers, alkylsulphonates, alkyl sulphates, arylsulphonates as well as protein hydrolysates; suitable dispersants are: for example lignin-sulphite waste liquors and methylcellulose.

Adhesives such as carboxymethylcellulose and natural and synthetic polymers in the form of powders, granules or latices, such as gum arabic, polyvinyl alcohol and polyvinyl acetate, and natural phospholipids, such as cephalins and lecithins, and synthetic phospholipids, can be used in the formulations. Other additives can be mineral and vegetable oils.

It is possible to use colorants such as inorganic pigments, for example iron oxide, titanium oxide and Prussian Blue, and organic dyestuffs, such as alizarin dyestuffs, azo dyestuffs and metal phthalocyanine dyestuffs, and trace nutrients such as salts of iron, manganese, boron, copper, cobalt, molybdenum and zinc.

The formulations in general comprise between 0.1 and 95% by weight of active compound, preferably between 0.5 and 90%, and additionally preferably extenders and/or surfactants.

The active compound content of the use forms prepared from the commercially available formulations can vary within wide ranges. The active compound concentration of the use forms can be in the range of from 0.0000001 up to 95% by weight of active compound, preferably between 0.0001 and 1% by weight.

Application is in a customary manner which is appropriate for the use forms.

### USE EXAMPLES

### Plant Bugs (Miridae)

Very especially preferred is the control of the following species from the plant bug family (Miridae):

Lygus lineolaris, Lygus spinolai in carrots, tuber vegetables, root vegetables and stem vegetables, such as, for example, asparagus, fruit vegetables such as, for example, bell peppers, tomatoes, cucumbers; potatoes, cotton, Brassica vegetables, pome fruit, soft fruit, such as, for example, strawberries; soybeans, tea.

Plesiocoris rugicollis in pome fruit

### Example 1A

Plots approximately 4 m² in size which are planted with tea plants c.v. “Yabukita” are treated, in 3 replications, against Lygus spinolai. Here, the active substance Example (I-4) (150 OD) is tested at the specified application rate against the commercial standard Imidacloprid (10 WP) at the specified application rate. The application is effected with an engine-driven knapsack sprayer. Here, the treatment is carried out with a water application rate of 10 000 l/ha.

The test is evaluated 15 and 29 days after the treatment by determining the destruction of the nymphs on the shoots.

| | |
|---|---|
| | Efficacy |
| Active | (% Abbott) |

| substance | Application rate (%) a.s. | 15 d | 29 d |
|---|---|---|---|
| Imidacloprid | 0.005 | 35.7 | 48.1 |
| Example (I- | 0.01 | 92.9 | 100 |
| 4) | | | |

### Example 1B

Apple trees cv. “Holsteiner Cox” which are approximately 14 years old are treated, in 3 replications, against the apple capsid bug (Plesiocoris rugicollis). Here, the active substance Example (I-4) (150 OD) is tested at the specified application rate against the commercial standard Deltamethrin liquid (EC 025) at the specified application rate. The application is carried out with a knapsack sprayer. Here, the treatment is effected with a water application rate of 500 l/ha/m crown level.

The test is evaluated 37 days after the treatment by scoring the destruction of the larvae on the twigs with the aid of the Abbott method.

| Active | Application rate (g) | Efficacy (%) Abbott |
|---|---|---|
| substance | a.s./ha/m crown level | 37 d |
| Deltamethrin | 3.75 | 78 |
| Example (I- | 30 | 96 |
| 4) | | |

### Thrips (Thripidae)

Furthermore very especially preferred is the control of the following species from the thrips family (Thripidae) in the following crops:

| | |
|---|---|
| Frankliniella occidentalis | in vegetables such as, for example, bell peppers, tomatoes, |
| Frankliniella schultzei | cucumbers, cabbage, for example broccoli, beans, lettuce, |
| Frankliniella fusca | aubergines, courgettes, pumpkins, in soft fruit, for example |
| | strawberries, in melons, for example water melons, musk |
| | melons, Cantaloupe melons, in ornamentals such as roses, |
| | hibiscus, chrysanthemums and in potatoes and in tropical |
| | crops such as, for example, papayas, avocado, cotton, conifers |
| Thrips palmi | in cotton, in vegetables such as, for example, bell peppers, |
| Thrips tabaci | tomatoes, cucumbers, beans, cucurbits, aubergines, courgettes, |
| Thrips hawaiiensis | cabbage, leeks, onions, in soft fruit, in melons, for example |
| | water melons, musk melons, Cantaloupe melons, in |
| | ornamentals such as, for example, roses, hibiscus, in tropical |
| | crops such as, for example, papayas, pineapples, bananas, |
| | potatoes, grapevines, cotton, rice, nuts |
| Heliothrips | in vegetables such as, for example, tomatoes, bell peppers, |
| haemorrhoidalis | beans, cucumbers, pumpkins, aubergines, in melons and in |
| | ornamentals such as, for example, roses, hibiscus, azaleas, |
| | tropical crops such as guavas, citrus such as, for example, |
| | lemons, oranges, grapevines, nuts, such as, for example, |
| | macadamia nuts |
| Hercinothrips femoralis | in tropical crops such as, for example, bananas, ornamentals, |
| Hercinothrips bicinctus | vegetables such as, for example, beans |
| Hercinothrips phaseoli | |
| Caliothrips phaseoli | in vegetables such as, for example, beans, courgettes, in |
| | tropical fruit such as, for example, avocados |
| Baliothrips biformis | in rice |
| Anaphothrips obscurus | in maize, Brassica vegetables such as, for example, white |
| | cabbage, cereals such as, for example, wheat |
| Scirthothrips aurantii | in citrus such as, for example, oranges, lemons, grapefruits, |
| Scirthothrips dorsalis | tangerines, ornamentals, vegetables such as, for example, |
| Scirthothrips citri | cucumbers, tomatoes, beans, aubergines, pumpkins; melons |
| | such as water melons, Cantaloupe melons, spices such as |
| | chilli; tea |

### Example 2

Plots 10 m² in size which are planted with bell peppers cv. “Zingaro” are treated, in three replications, against Frankliniella occidentalis. The application is effected with a knapsack sprayer which is operated with pressurized air. Here, the active substances Example (I-9) (240 SC) and Example (I-4) (240 SC), in the form of a tank mix together with 0.1% a.s. rapeseed oil methyl ester (500 EW) and the commercial standard acrinathrin (075 EW), are applied at the specified application rates. Two applications are carried out at an interval of 24 days, with a water application rate of 10001/ha.

The test is evaluated 17 and 21 days after treatment 1 and 4 days after treatment 2 by scoring the destruction of the animals (nymphs) on the flowers.

| Active | | Efficacy (% Abbott) | | |
|---|---|---|---|---|
| substance | Application rate g a.s./ha | 17 d (1) | 21 d (1) | 4 d (2) |
| Acrinathrin | 60 | 98 | 91 | 87 |
| Example (I-9) | 54 | 86 | 84 | 63 |
| Example (I-4) | 60 | 71 | 85 | 80 |

### Example 3

Plots approx. 22 m² in size which are planted with courgettes cv. “Italiana negra” are treated, in three replications, against Caliothrips phaseoli. The application is effected with a motor-driven knapsack sprayer. Here, the active substance Example (I-4) (240 SC), in a tank mix together with 0.1% a.s. rapeseed oil methyl ester (500 EW) and the commercial standard endosulfan (350 EC), is tested at the specified application rates. The water application rate is approx. 510 l/ha.

The test is evaluated 8 days after the treatment by scoring the destruction of the animals (nymphs) on 5 leaves.

| Active | Application | Efficacy (% Abbott) |
|---|---|---|
| substance | rate g a.s./ha | 8 d |
| Endosulfan | 525 | 67.0 |
| Example (I-4) | 72 | 71.3 |

### Example 4

Plots 10 m² in size which are planted with aubergines cv. “Dumaguete Long Purple” are treated, in three replications, against Thrips palmi. The application is effected with a knapsack sprayer which is operated with pressurized air. Here, the active substance Example (I-4) (240 SC), in a tank mix together with 0.2% a.s. rapeseed oil methyl ester (240 SC) and the commercial standard Imidacloprid (100 SL): is tested at the specified application rates. The water application rate is 400 l/ha. Three applications are carried out at intervals of 8 and 7 days, respectively.

The test is evaluated in each case 4 days after treatment 2 and 7, 14 and 21 days after treatment 3 by scoring the destruction of the nymphs on the leaves.

| | Application | | | | |
|---|---|---|---|---|---|
| | rate % a.s. | | Efficacy (% Abbott) | | |
| | | 4 d | 7 d | 14 d | 21 d |
| Active | | after | after | after | after |
| substance | | treatm. 2 | treatm. 3 | treatm. 3 | treatm. 3 |
| Imidacloprid | 0.01 | 82.9. | 75.0 | 62.1 | 53.1 |
| Example (I- | 0.0096 | 82.9 | 75.0 | 82.8 | 90.6 |
| 4) | | | | | |

### Example 5

Plots 6 m² in size which are planted with aubergines cv. “Soraya” are treated, in three replications, against Frankliniella occidentalis. The application is effected with a motor-operated knapsack sprayer. Here, the active substances Example (I-4) (240 SC) and Example (I-9) (240 SC), in a tank mix together with 0.1% a.s. rapeseed oil methyl ester (500 EW) and the commercial standard Spinosad (480 SC), are tested at the specified application rates. The water application rate is 1500 l/ha.

The test is evaluated 25, 32 and 39 days after the treatment by scoring the destruction rate of the mixed populations on the leaves.

| Active | Application | Efficacy (% Abbott) | | |
|---|---|---|---|---|
| substance | rate % a.s. | 25 d | 32 d | 39 d |
| Spinosad | 0.012 | 94.7 | 89.3 | 95.3 |
| Example (I-9) | 0.0054 | 71.1 | 62.1 | 92.5 |
| Example (I-4) | 0.012 | 92.1 | 88.3 | 89.7 |

### Example 6

Plots 15 m² in size which are planted with onions are treated, in two replications, against Thrips tabaci. The application is effected with a knapsack sprayer which is operated with pressurized air. Here, the active substances Example (I-4), in a tank mix together with 0.2% a.s. rapeseed oil methyl ester (500 EW) and the commercial standard dimethoate and (380 EC), are tested at the specified application rates in a tank mix with 0.9% a.s. E-actipron (900 EC). The water application rate is 300 l/ha.

The test was evaluated 43 and 62 days after the treatment by scoring the destruction rate of the population on the leaves.

| | | |
|---|---|---|
| | | Efficacy |
| Active | Application | (% Abbott) |

| substance | rate g a.s./ha | 43 d | 62 d |
|---|---|---|---|
| Dimethoate | 380 | 64.5 | 74.8 |
| Example (I-4) | 96 | 83.0 | 84.5 |

### Example 7

Plots approximately 16.5 m² in size which are planted with aubergines are treated, in three replications, against Thrips palmi. Here, the active substance Example (I-4) and the commercial standard Imidacloprid (100 SL) is applied at the specified application rates, using a knapsack sprayer which is operated with compressed air. The water application rate is 750 l/ha. In the case of Example (I-4), 0.2% a.s. rapeseed oil methyl ester (500 EW) is added to the spray mixture. Three applications are carried out at intervals of 7 and 14 days, respectively.

The destruction rate in percent is determined on in each case 20 leaves. The following results are obtained 7, 13 and 21 days after the second application:

| | | Efficacy | | |
|---|---|---|---|---|
| Active | Application | (% Abbott) | | |
| substance | rate a.s. in % | 7 d | 13 d | 21 d |
| Imidacloprid | 0.0151 | 72 | 68 | 24 |
| Example (I-4) | 0.0096 | 84 | 88 | 78 |

### Example 8

Plots approximately 14 m² in size which are planted with cotton are treated, in four replications, against Frankliniella sp. Here, the active substance Example (I-4) (240 SC) and the commercial standard acephate (90 SP) are applied at the specified application rates, using a mounted sprayer. The water application rate is 360 l/ha. The spray mixture of Example (I-4) has 0.1% a.s. rapeseed oil methyl ester (500 EW) added.

The activity is determined by assessing the sucking damage to the leaves, using a scale of from 1 to 6. 1 means no damage while 6 means complete damage. The following leaf damage is observed after 8 and 14 days:

| | |
|---|---|
| | Leaf |
| Active | damage (%) |

| substance | Application rate g a.s./ha | 8 d | 14 d |
|---|---|---|---|
| Example (I- | 60 | 2.0 | 1.6 |
| 4) | | | |
| Acephate | 1120 | 2.0 | 1.9 |

### Example 9

Plots approximately 10 m² in size which are planted with cucumbers are treated, in three replications, against Thrips palmi. The application is carried out with a knapsack sprayer which is operated with pressurized air. Here, the active substance Example (I-4) (240 SC), in a tank mix with 0.2% a.s. rapeseed oil methyl ester (500 EW) and the commercial standard Imidacloprid (100 SL), is applied at the specified application rates. The application is carried out with a water application rate of 750 l/ha. Two applications are carried out at an interval of 8 days.

The test is evaluated 3, 8, 11 and 15 days after treatment 1 by scoring the destruction rate of the animals (nymphs) on the leaves.

| Active | Application | Efficacy (% Abbott) | | | |
|---|---|---|---|---|---|
| substance | rate g a.s./ha | 3 d | 8 d | 11 d | 15 d |
| Imidacloprid | 100 | 85.3 | 85.5 | 91.7 | 77.1 |
| Example (I-4) | 72 | 64.5 | 91.0 | 80.4 | 70.1 |

### Example 10

Plots approx. 5 m² in size which are planted with tea plants cv. “Yabukita” which are approximately 18 years old are treated, in three replications, against Scirtothrips dorsalis. Here, the active substance Example (I-4) (100 OD) is tested, at the specified application rates, against the commercial standards Ethiprole (SC10 flowable) and Imidacloprid (50 WG). The application is carried out with a sprayer which is operated with pressurized air. The water application rate is 4500 l/ha. The test is evaluated 7 days after the treatment by scoring the destruction rate of the nymphs and the plants.

| Active | Application | Efficacy (% Abbott) |
|---|---|---|
| substance | rate (%) a.s. | 7 d |
| Ethiprole | 0.005 | 100 |
| Example (I-4) | 0.01 | 100 |
| Imidacloprid | 0.005 | 44.4 |

### Example 11

Plots approx. 26 m² in size which are planted with dwarf beans are treated 16 days after emergence against Thrips tabaci, in four replications. The application is carried out with a knapsack sprayer which is operated with pressurized air. Here, the active substances Example (I-2) (240 SC) (I-4) (240 SC) and Example (1-9) (240 SC), in a tank mix with 0.1% a.s. rapeseed oil methyl ester (500 EW), are tested against the commercial standard Profenofos (720 EC) at the specified application rates. The water application rate is 1000 l/ha. Two applications are carried out at an interval of 10 days.

The test is evaluated 5 and 11 days after the first treatment by scoring the destruction rate of the nymphs on the leaves.

| | |
|---|---|
| | Efficacy |
| Active | (% Abbott) |

| substance | Application rate (g) a.s./ha | 5 d | 11 d |
|---|---|---|---|
| Profenofos | 1300 | 80 | 75 |
| Example (I-9) | 54 | 67 | 95 |
| Example (I-2) | 54 | 33 | 90 |
| Example (I-4) | 60 | 60 | 90 |

### Cicadellidae

Furthermore very especially preferred is the control of the following species from the Cicadellidae family in the following crops:

| | |
|---|---|
| Empoasca devastans | in vegetables such as bell peppers, tomatoes, cucumbers, |
| Empoasca fabae | cabbage, for example broccoli, beans, lettuce, aubergines, |
| Empoasca flavescens | courgettes, pumpkins/squashes, celery/celeriac, peas, in soft |
| Empoasca kraemeri | fruit, in melons, for example watermelons, musk melons, |
| Empoasca onukui | Cantaloupe melons, in ornamentals such as roses, hibiscus, in |
| Empoasca biguttula | citrus such as oranges, tangerines, grapefruits, and in potatoes |
| Empoasca vitis | and in tropical crops such as, for example, papayas, bananas, |
| | cotton, tea, grapevines, nuts such as, for example, peanuts, |
| | pecan nuts, |
| Idioscopus clypealis | in vegetables such as bell peppers, tomatoes, cucumbers, |
| Idioscopus niveosparsus | beans, cucurbits, aubergines, courgettes, cabbage, in soft fruit, |
| Idioscopus nitidulus | in melons, for example watermelons, musk melons, |
| | Cantaloupe melons, in ornamentals, in tropical crops such as, |
| | for example, mangoes, bananas |
| Oncometopia fascialis | in melons and ornamentals such as, for example, roses, |
| Oncometopia nigricans | hibiscus, citrus such as, for example, oranges, nuts such as |
| | pistachios |
| Erythroneura apicalis | in grapevines |
| Erythroneura eburnea | |
| Erythroneura elegantulus | |
| Erythroneura variabilis | |
| Homalodisca cougulata | in citrus such as oranges, tangerines, lemons, grapefruits, |
| | limes, kumquats, grapevines |
| Circulifer tenellus | in vegetables such as, for example, pumpkins/squashes |
| Dalbus maidis | in vegetables, for example dwarf beans |

### Example 12

Plots 10 m² in size which are planted with cotton are treated, in three replications, against Empoasca biguttula. The application is carried out with a knapsack sprayer operated with pressurized air. Here, the active substance Example (I-4) (240 SC), in a tank mix with 0.2% a.s. rapeseed oil methyl ester (500 EW), is tested against the commercial standards Imidacloprid (SL 100) and Buprofezin (WP50) at the specified application rates. Two applications are carried out at an interval of 7 days. The water application rate is 750 l/ha.

The test is evaluated 3, 7, 14 and 21 days after the second treatment by counting the live animals. Thereafter, the efficacy is calculated in percent, using the formula of Henderson and Tilton.

| Active | | Efficacy (% H + T) | | | |
|---|---|---|---|---|---|
| substance | Application rate (g) a.s./ha | 3 d | 7 d | 14 d | 21 d |
| Imidacloprid | 30 | 97.3 | 99.6 | 95.6 | 72.5 |
| Example (I-4) | 24 | 92.1 | 92.9 | 84.4 | 72.6 |
| Buprofezin | 50 | 96.5 | 94.7 | 90.1 | 67.1 |

### Example 13

Plots approx. 10 m² in size which are planted with dwarf beans cv. “Carioquinha” are treated, in three replications, against Dalbulus maidis. The application is carried out with a knapsack sprayer which is operated with pressurized air. Here, the active substances Example (I-4) (240 SC) and Example (1-9) (240 SC), in a tank mix with 0.1% a.s. rapeseed oil methyl ester (500 EW) and the commercial standard Imidacloprid (200 SL), are applied at the specified application rates. Two applications are carried out at an interval of 7 days, using a water application rate of 300 l/ha.

The test is evaluated 7 and 11 days after the second treatment by scoring the destruction rate of the animals (nymphs) on the leaves.

| | |
|---|---|
| | Efficacy |
| Active | (% Abbott) |

| substance | Application rate (g) a.s./ha | 7 d | 11 d |
|---|---|---|---|
| Imidacloprid | 96 | 82 | 74 |
| Example (I-4) | 96 | 73 | 69 |
| Example (I-3) | 96 | 78 | 75 |

### Example 14

A mango tree which is approximately 14 years old is treated, in three replications, against Idioscopus clypealis. The application is carried out with a high-pressure sprayer. Here, the active substance Example (I-4) (240 SC), in a tank mix with 0.2% a.s. rapeseed oil methyl ester (500 EW) and the commercial standards Imidacloprid (100 SL) and Pymetrozine (WP 25), is tested at the specified application rates. The amount of spray mixture is 10 l/tree. Five treatments are carried out at intervals of 7, 14, 21 and 28 days.

The test is evaluated in each case 7 days after treatments 3 to 5 by scoring the destruction rate of the nymphs on the infructescences.

| | Application | Efficacy (% Abbott) | | |
|---|---|---|---|---|
| Active | rate | 7 days after | 7 days after | 7 days after |
| substance | (%) | treatment 3 | treatment 4 | treatment 5 |
| Imidacloprid | 0.00025 | 69.1 | 82.2 | 86.4 |
| Example (I-4) | 0.0016 | 54.7 | 98.1 | 99.4 |
| Pymetrozine | 0.002 | 70.9 | 98.6 | 94.8 |

### Example 15

Plots approx. 4 m² in size which are planted with tea plants cv. “Yabukita” are treated, in three replications, against Empoasca onukui. The application is carried out with a knapsack sprayer which is operated with pressurized air. Here, the active substance Example (I-4) (150 OD) is tested against the commercial standard Admire (10 WP) at the specified application rates. The water application rate is 10 000 l/ha.

The test is evaluated 15 and 29 days after the treatment by scoring the destruction rate of the larvae in percent on the shoots.

| | | |
|---|---|---|
| | | Efficacy |
| Active | Application rate (%) | (% Abbott) |

| substance | a.s. | 15 d | 29 d |
|---|---|---|---|
| Admire | 0.005 | 89.2 | 91.8 |
| Example (I-4) | 0.01 | 73 | 78.8 |

### Example 16

Plots 10 m² in size which are planted with aubergines are treated, in three replications, against Empoasca biguttula. The application is carried out with a knapsack sprayer which is operated with pressurized air. Here, the active substance Example (I-4) (150 OD) is tested against the commercial standards Imidacloprid (SL 100) and Profenofos (500 EC) at the specified application rates. Two applications are carried out at an interval of 7 days. The water application rate is 750 l/ha.

The test is evaluated 2, 6 and 13 days after the first treatment by scoring the destruction rates of the animals (nymphs) on the plants.

| Active | Application | Efficacy (% Abott) | | |
|---|---|---|---|---|
| substance | rate (g) a.s./ha | 2 d | 6 d | 13 d |
| Imidacloprid | 30 | 38.1 | 71.6 | 58.7 |
| Example (I-4) | 50 | 52.4 | 56.0 | 66.7 |
| Profenofos | 500 | 41.3 | 65.1 | 53.8 |

### Leaf Miners (Agromyzidae)

Furthermore very especially preferred is the control of the following species from the leaf miner family (Agromyzidae) in the following crops:

| | |
|---|---|
| Liriomyza brassicae | in vegetables such as bell peppers, tomatoes, |
| Liriomyza bryoniae | cucumbers, cabbage, beans, lettuce, |
| Liriomyza cepae | aubergines, courgettes, pumpkins/squashes, |
| Liriomyza chilensis | in melons, for example watermelons, musk |
| Liriomyza hunidobrensis | melons, Cantaloupe melons, in ornamentals |
| Liriomyza sativae | such as roses, hibiscus, and in potatoes, beet, |
| Liriomyza trifolie | |
| Liriomyza quadrata | |
| Pegomya hyoscyami | in beet, in vegetables and cereals, for example |
| Pegomya spinaciae | wheat |

### Example 17

Plots approx. 25 m² in size which are planted with winter wheat cv. “Capfern” are treated, in four replications, against Pegomya spp. The application is carried out with a knapsack sprayer which is operated with pressurized air. Here, the active substance Example (I-4) (240 SC), in a tank mix with 0.2% a.s. rapeseed oil methyl ester (500 EW) and the commercial standard Thiacloprid (240 OD), is tested at the specified application rates. Two applications are carried out at an interval of 7 days. The water application rate is 350 l/ha.

The test is evaluated 3 days after the last treatment by scoring the destruction rate of the larvae on the plants.

| | Application rate g | Efficacy (% Abbott) |
|---|---|---|
| Active substance | a.s./ha | 10 d |
| Thiacloprid | 72 | 100 |
| Example (I-4) | 96 | 100 |

### Example 18

Plots approx. 10 m² in size which are planted with beans cv. “Lago Azul” are treated, in three replications, against Liriomyza sp. Here, the active substance Example (I-4) (150 OD) and the commercial standards Cyromazine (WP 75) and Abamectin (EC 018) are applied at the specified application rates, using a knapsack sprayer which is operated with pressurized gas. The water application rate is 400 and 500 l/ha., respectively. Three applications are carried out at intervals of in each case 7 days.

The destruction rate in percent is determined on in each case 10 leaves. 2, 7, 12, 18, 20 and 25 days after the first treatment, the following results are obtained:

| | Application | | | | | | |
|---|---|---|---|---|---|---|---|
| Active | rate | Efficacy (% Abbott) | | | | | |
| substance | (g) a.s./ha | 2 d | 7 d | 12 d | 18 d | 20 d | 25 d |
| Cyromazine | 130 | 44 | 61 | 42 | 54 | 32 | 0 |
| Example (I-4) | 100 | 40 | 69 | 30 | 43 | 57 | 46 |
| Abamectin | 14.4 | 36 | 80 | 52 | 70 | 43 | 60 |

### Gall Midges (Cecidomyiidae)

Furthermore very especially preferred is the control of the following species from the gall midge family (Cecidomyiidae):

Dasineura brassicae, Dasineura mali, Dasineura piri in carrots, tuber vegetables, root vegetables and stem vegetables such as, for example, asparagus, fruit vegetables such as, for example, bell peppers, tomatoes, cucumbers; potatoes, cotton, Brassica vegetables, pome fruit, spices.

Prodiplosis vaccinii, Prodiplosis longifila, Thecodiplosis brachyntera, Thecodiplosis japonensis, Sitodiplosis mosellana, Haplodiplosis equestris in vegetables such as, for example, fruit vegetables (tomatoes, bell peppers), citrus (for example lemons, oranges, grapefruits, clementines), cereals (for example wheat, barley), conifers and afforestations.

Contarinia lycopersici, Contarinia maculipennis, Contarinia humuli, Contarinia johnsoni, Contarinia nasturti, Contarinia okadai, Contarinia tritici, Contarinia pisi, Contarinia sorghicola, Contarinia medicaginis, Contarinia mali in vegetables such as, for example, Brassica vegetables, fruit vegetables, cereals such as, for example, wheat, sorghum; pome fruit; hops.

### Example 19a)

Apple trees cv. “Elan” which are approximately 16 years old are treated, in 3 replications, against the Dasineura mali. Here, the active substance Example (I-4) (100 OD) is tested at the specified application rate against the commercial standard and Pirimicarb (50 WG) at the specified application rate. The application is carried out with a spray diffuser. Here, the treatment is effected with a water application rate of 1000 l/ha/m crown level.

The test is evaluated 59 days after the treatment by scoring the destruction of the larvae on the basis of the adults present on the twigs with the aid of the Abbott method.

| Active | Application rate (g) | Efficacy (%) Abbott |
|---|---|---|
| substance | a.s./ha/m crown level | 59 d |
| Pirimicarb | 125 | 0 |
| Example (I-4) | 72 | 95.1 |

### Example 19b)

Fully-grown pear trees cv. “Conference” of crown height approx. 3.5 m are treated, in four replications, against Dasineura pyri. Here, the active substance Example (I-4) is tested as (150 OD) and (240 SC) together with 0.1% a.s. rapeseed oil methyl ester (Mero 733 1R) in a tank mix at the specified application rate against the commercial standard Endosulfan (350 EC) at the specified application rate. The application is carried out with a spray diffuser. Here, the treatment is effected with a water application rate of 1000 l/ha/m crown level. Two applications are carried out at an interval of 7 days.

The test is evaluated 9 days after treatment 2 by scoring the destruction rate of the larvae in the rolled leaves, using the Abbott method.

| | Application rate | |
|---|---|---|
| Active | (g) a.s./ha/m crown | Efficacy (% Abbott) |
| substance | level | 9 d |
| Endosulfan | 472.5 | 71.6 |
| Example (I-4) | 120 | 94.6 |
| 240 SC + | | |
| Mero | | |
| Example (I-4) | 150 | 100 |
| 150 OD | | |

### Fruit Flies (Tephritidae)

Furthermore very especially preferred is the control of the following species from the fruit fly family (Tephritidae) in the following crops:

| | |
|---|---|
| Anastrepha fraterculus | in vegetables such as, for example, bell peppers, tomatoes, |
| Anastrepha ludens | cucumbers, beans, aubergines, courgettes, pumpkins/squashes, |
| Anastrepha striata | in soft fruit, for example strawberries, in melons, for example |
| Anastrepha oligua | watermelons, musk melons, Cantaloupe melons, in pome fruit, |
| Anastrepha distineta | stone fruit, in ornamentals such as roses, hibiscus, |
| | chrysanthemums, and in potatoes, grapevines and in tropical |
| | crops such as, for example, papayas, avocado, guava, |
| | mangoes, in citrus, such as, for example, oranges, clementines, |
| | grapefruits |
| Ceratitis capitata | in cotton, in vegetables such as, for example, bell peppers, |
| Ceratitis cosyra | tomatoes, cucumbers, beans, cucurbit, aubergines, courgettes, |
| Ceratitis rosa | cabbage, leeks, onions, in soft fruit, in melons such as, for |
| | example, watermelons, musk melons, in pome and stone fruit, |
| | in ornamentals such as, for example, roses, hibiscus, in |
| | tropical crops such as, for example, papayas, kaki fruit, |
| | pineapples, bananas, potatoes, grapevines, in citrus such as, for |
| | example, oranges, clementines, grapefruits |
| Dacus oleae | in vegetables such as, for example, tomatoes, bell peppers, |
| Dacus ciliatus | beans, cucumbers, pumpkins/squashes, aubergines, in melons |
| Dacus dorsalis | and in ornamentals such as, for example, roses, hibiscus, |
| Dacus cucurbitae | azaleas; tropical crops such as kaki fruit, guavas, citrus such |
| Dacus tyroni | as, for example, lemons, oranges; grapevines, olives, soft fruit |
| Dacus tsuseonis | such as, for example, strawberries |
| Rhagoletis cerasi | in citrus such as, for example, oranges, lemons, grapefruits, |
| Rhagoletis completa | tangerines, ornamentals, vegetables such as, for example, |
| Rhagoletis pomonella | cucumbers, tomatoes, beans, aubergines, pumpkins/squashes; |
| | melons such as watermelons, Cantaloupe melons; pome and |
| | stone fruit; soft fruit such as, for example, strawberries |

### Example 20

Peach trees cv. “Oom Sarel” which are approximately 10 years old are treated, in three replications, against Ceratitis capitata. The application is carried out with a high-pressure sprayer or a knapsack sprayer which is operated with pressurized air. Here, the active substance Example (I-4) (150 OD) and the commercial standard Fenthion (500 EC) are tested at the specified application rates. The water application rate is 2500 l/ha. Three applications are carried out at an interval of 7 and 19 days, respectively.

The test is evaluated 9 and 16 days after treatment 3 by scoring the destruction rate of the animals on the fruits with the aid of the Abbott formula.

| | | Efficacy (% Abbott) | |
|---|---|---|---|
| Active | Application rate | 9 d | 16 d after |
| substance | g a.s./ha | after treatment 3 | treatment 3 |
| Fenthion | 1700 | 86.7 | 88.9 |
| Example (I-4) | 100 | 86.7 | 100 |

### Example 21

Chemy trees cv. “Van” which are approximately 26 years old are treated, in three replications, against Rhagoletis cerasi. The application is carried out with an atomizer. Here, the active substance Example (I-4) (150 OD) and the commercial standard dimethoate (400 EC) are applied at the specified application rates. Two applications are carried out at an interval of 6 days with a water application rate of 500 l/ha/m crown level.

The test is evaluated 23 days after treatment 2 by scoring the destruction rates of the animals (larvae) on the fruits with the aid of the Abbott formula.

| Active | Application rate | Efficacy (% Abbott) |
|---|---|---|
| substance | g a.s./ha/m crown level | 23 d |
| Dimethoate | 200 | 100 |
| Example (I-4) | 75 | 100 |

### Example 22A

Plots approx. 10 m² in size which are planted with bottle gourds cv. “Waltham” are treated, in three replications, against Dacus ciliatus. The application is carried out with a motor-operated knapsack sprayer. Here, the active substance Example (I-4) (150 OD) and the commercial standard Fenthion (500 EC) are tested at the specified application rates. Three applications are carried out at in each case an interval of 7 days. The water application rate is approx. 500 l/ha.

The test is evaluated 8, 14 and 21 days after treatment 1 by scoring the infestation of the fruits.

| Active | Application | Efficacy (% Abbott) | | |
|---|---|---|---|---|
| substance | rate g a.s./ha | 8 d | 14 d | 21 d |
| Fenthion | 300 | 59.6 | 48.9 | 60.3 |
| Example (I-4) | 200 | 59.5 | 48.9 | 44.5 |

### Example 22B

In a laboratory experiment, 40 olives are treated, in four replications, against the olive fruit fly (Dacus oleae) three days after oviposition. Here, the active substance (1-4) (100 OD) and the commercial standards Fenthion (500 EC) and Imidacloprid (200 SL) are tested at the specified application rates.

The test is evaluated 14 days after oviposition by counting the number of feeding tunnels (larval development completed), while the absence of such feeding tunnels indicates the efficacy against the larvae.

| Active | Application | Number of feeding tunnels (%) |
|---|---|---|
| substance | rate % | 14 days after oviposition |
| Imidacloprid | 0.01 | 11.9 |
| Example (I- | 0.02 | 3.1 |
| 4) | | |
| Fenthion | 0.05 | 1.9 |
| untreated | — | 84.4 |

### Leaf Beetles (Chrysomelidae)

Furthermore very especially preferred is the control of the following species from the leaf beetle family (Chrysomelidae) in the following crops:

| | |
|---|---|
| Aulacophora femoralis | in vegetables such as bell peppers, tomatoes, |
| Aulacophora similis | cucumbers, beans, lettuce, aubergines, |
| | courgettes, pumpkins, squashes, in |
| | soft fruits, in melons, for example |
| | watermelons, musk melons, |
| | Cantaloupe melons, |
| Lema lichenis | in cereals, rice |
| Lema melanopa | |
| Lema oryzae | |
| Lema bilineata | |
| Leptinotarsa | in tomatoes, potatoes |
| decemlineata | |
| Phyllotreta undulata | in vegetables such as Brassica vegetables, fruit |
| | vegetables, in oilseed rape |
| Haltica lythri | in grapefines |

### Example 23

Plots approx. 10 m² in size which are planted with potatoes “Quarta” are treated, in three replications, against Leptinotarsa decemlineata. The application is carried out with a knapsack sprayer operated with pressurized air. Here, the active substance Example (I-4) (240 SC), in a tank mix together with 0.2% a.s. rapeseed oil methyl ester (500 EW) and the commercial standard Deltamethrin (100 EC), is tested at the specified application rate. The water application rate is 300 l/ha.

The test is evaluated 3, 8 and 20 days after the treatment by scoring the destruction rate of the animals (larvae) on the plants.

| | Application | | | |
|---|---|---|---|---|
| Active | rate g | Efficacy (% Abbott) | | |
| substance | a.s./ha | 3 d | 8 d | 20 d |
| Deltamethrin | 75 | 100 | 100 | 100 |
| Example (I-4) | 72 | 53.3 | 72.7 | 84.4 |

### Example 24

Plots approx. 12 m² in size which are planted with aubergines cv. “DLP” are treated, in three replications, against flea beetles (Phyllotreta sp.). The application is carried out with a knapsack sprayer which is operated with pressurized air. Here, the active substance Example (I-4) (100 OD) and the commercial standards Imidacloprid (100 SL) and Profenofos (500 EC) are applied at the specified application rates. Four applications are carried out at intervals of 7, 8 and 10 days, with a water application rate of 750 l/ha.

The test is evaluated 7 days after the last treatment by scoring the destruction rate of the larvae on the plants.

| | Application rate g | Efficacy (% Abbott) |
|---|---|---|
| Active substance | a.s./ha | 7 d |
| Imidacloprid | 100 | 98 |
| Example (I-4) | 70 | 89 |
| Profenofos | 500 | 84 |

### Example 25

Plots approx. 25 m² in size which are planted with winter wheat cv. “Capfern” are treated, in four replications, against Lema melanopa. The application is carried out with a knapsack sprayer which is operated with pressurized air. Here, the active substance Example (I-4) (240 SC), in a tank mix together with 0.2% a.s. rapeseed oil methyl ester (500 EW) and the commercial standard Calypso (240 OD), is applied at the specified application rates. Two applications are carried out at an interval of 7 days, with a water application rate of 350 l/ha.

The test is evaluated 3 days after the last treatment by scoring the destruction rate of the larvae on the plants.

| Active | Application rate g | Efficacy (% Abbott) |
|---|---|---|
| substance | a.s./ha | 10 d |
| Calypso | 72 | 96.4 |
| Example (I-4) | 96 | 82.1 |

### True Weevils (Curculionidae)

Furthermore very especially preferred is the control of the following species from the true weevil family (Curculionidae) in the following crops:

| | |
|---|---|
| Anthonomus grandis | in cotton, in pome fruit such as apples, |
| Anthonomus pomorum | soft fruit such as strawberries |
| Anthonomus signatus | |
| Lissorhoptus oryzae | in rice |
| Ceutorhynchus brassicae | in oilseed rape |
| Ceutorhynchus napi | |
| Ceutorhynchus assimilis | |
| Ceutorhynchus picitarsis | |
| Ceutorhynchus | |
| quadridens | |
| Premnotrypes vorax | in potatoes |

### Example 26-A

Plots approx. 25 m² in size which are planted with oilseed rape cv. “Artus” are treated, in four replications, against Ceutorhynchus napi. The application is carried out with a motor-operated knapsack sprayer. Here, the active substance Example (I-4), in a tank mix with 0.2% a.s. rapeseed oil methyl ester (500 EW) and the commercial standards Deltamethrin (25 EC), lambda-cyhalothrin (S100) and Thiacloprid (OD 240), is tested at the specified application rates. The water application rate is 250 l/ha.

The test is evaluated 55 days after the treatment by scoring the destruction rate of the larvae on the plants.

| | Application | Efficacy |
|---|---|---|
| Active | rate g | (% Abbott) |
| substance | a.s./ha | 55 d |
| Deltamethrin | 5 | 77.1 |
| Example (I-4) | 72 | 74.3 |
| Thiacloprid | 72 | 52.4 |
| Lambda-cyhalothrin | 5 | 89.5 |

### Example 26B

Apple trees cv. “Holsteiner Cox” in plots approx. 20 m² in size are treated, in 4 replications, against Anthonomus pomorum, the apple blossom weevil. Here, the active substance Example (I-4) (150 OD) at the specified application rate is tested against a tank mix of the commercial standards Thiacloprid (SC 480) and Deltamethrin-liquid in the specified application rates. The application is carried out with a knapsack sprayer. Here, the treatment is effected with a water application rate of 500 l/ha/m crown level.

The test is evaluated 22 days after the treatment by scoring the destruction of the larvae on the inflorescences with the aid of the Abbott method.

| Active | Application rate (g) | Efficacy (%) Abbott |
|---|---|---|
| substance | a.s./ha/m crown level | 22 d |
| Thiacloprid + | 48 + 3.75 | 88 |
| Deltamethrin | | |
| Example (I-4) | 48 | 88 |

### Leaf Miners (Gracillaridae)

Furthermore very especially preferred is the control of the following species from the leaf miner subfamily (Phyllocnistinae) in the following crops:

| | |
|---|---|
| Phyllocnistis citrella | in citrus such as oranges, clementines, |
| | grapefruits, lemons |
| Lithocolletis ringoniella | in pome and stone fruit, nuts |
| Lithocolletis crataegella | |
| Lithocolletis coryfoliella | |
| Leucoptera coffeella | in coffee |

### Example 27

Small orange trees on plots approximately 30 m² in size are treated, in four replications, against Phyllocnistis citrella. The application is carried out with a motor-operated knapsack sprayer. Here, the active substance Example (I-4) (150 OD) is tested against the commercial standard Imidacloprid (192 SC) at the specified rates. The water application rate is 935 l/ha.

The test is evaluated 7 and 14 days after the treatment by scoring the destruction rates of the larvae on the shoots in percent.

| | | |
|---|---|---|
| | Application | Efficacy |
| Active | rate (g) | (% Abbott) |

| substance | a.s./ha | 7 d | 14 d |
|---|---|---|---|
| Imidacloprid | 140 | 91.7 | 52.3 |
| Example (I-4) | 132 | 97.9 | 68.2 |

### Tortrix Moths (Tortricidae)

Also very especially preferred is the control of the following species from the tortrix moth family (Tortricidae) in the following crops: Laspeyresia molesta in pome and stone fruit such as, for example, peaches, nectarines, apricots; Carpocapsa pomonella in pome fruit; Clysia ambiguella in grapevines; Lobesia botrana in grapevines.

### Example 28

Approx. 10-year-old peach trees are treated, in four replications, against the oriental fruit moth (Laspeyresia molesta). The application is carried out with a knapsack sprayer which is operated with pressurized air. Here, the active substance (I-4) (150 OD) is tested against the commercial standards Pyriproxyfen (35 WP) and Acetamiprid (30 SG) at the specified application rates. The water application rate is 935 l/ha.

The test is evaluated 41 days after the treatment by scoring the destruction rate of the animals on the trees.

| Active | Application rate (g) | Efficacy (% Abbott) |
|---|---|---|
| substance | a.s./ha | 41 d |
| Pyrifroxyfen | 123 | 39.0 |
| Acetamiprid | 168 | 35.8 |
| Example (I-4) | 153 | 48.1 |

### Example 29

Approx. 15-year-old apple trees cv. “Golden Delicious” are treated, in four replications, against Carpocapsa pomonella. The application is carried out with an atomizer. Here, the active substance Example (I-4) (240 SC) in a tank mix together with 0.1% a.s. of the adjuvant Steffes Mero (rapeseed oil methyl ester) (733 1R) and the commercial standard Chlorpyrifos-methyl (25 WP) are tested at the specified application rates. The water application rate is 1052 l/ha. Two applications are carried out at an interval of 13 days.

The test is evaluated 32 days after treatment 2 by scoring the fruit damage with the aid of the Abbott formula.

| | | Efficacy (% Abbott) |
|---|---|---|
| | Application rate | 32 d |
| Active substance | g a.s./ha | after treatment 2 |
| Chlorpyrifos- | 0.1 | 66.7 |
| methyl | | |
| Example (I-4) | 0.012 | 73.7 |

### Example 30

Approx. 16-year-old apple trees cv. “Golden Delicious” are treated, in four replications, against Carpocapsa pomonella. The application is carried out with a spray diffuser. Here, the active substance Example (I-4) (150 OD) is applied in comparison with Imidacloprid (200 SC) at the specified application rates. Two applications are carried out at an interval of 16 days, with a water application rate of 1000 l/ha.

The test is evaluated 14 days after treatment 2 by scoring the fruit damage with the aid of the Abbott formula.

| Active | Application rate | Efficacy |
|---|---|---|
| substance | (%) | (% Abbott) |
| Imidacloprid | 0.015 | 26.3 |
| Example (I-4) | 0.015 | 73.7 |

### Sawflies (Tenthredinidae)

Also very especially preferred is the control of the following species from the sawfly family (Tenthredinidae):

| | |
|---|---|
| Hoplocampa brevis, | in pome fruit and stone fruit |
| Hoplocampa testudinea, | |
| Hoplocampa flava, | |
| Hoplocampa minuta | |
| Nematus ribesii | in soft fruit, for example gooseberries |
| Caliroa cerasi | in stone fruit, for example cherries |

### Example 31

Apple trees cv. “Holsteiner Cox” in plots approx. 20 m² in size are treated, in 4 replications, against sawflies Hoplocampa sp. Here, the active substance Example (I-4) (150 OD) at the specified application rate is tested against a tank mix of the commercial standards Thiacloprid (SC 480) and Deltamethrin-liquid in the specified application rates. The application is carried out with a knapsack sprayer. Here, the treatment is effected with a water application rate of 500 l/ha/m crown level.

The test is evaluated 57 days after the treatment by scoring the destruction of the larvae on the fruits with the aid of the Abbott method.

| Active | Application rate (g) | Efficacy (%) Abbott |
|---|---|---|
| substance | a.s./ha/m crown level | 57 d |
| Thiacloprid + | 48 + 3.75 | 94 |
| deltamethrin | | |
| Example (I- | 48 | 98 |
| 4) | | |

What is claimed is:

1. A method for controlling insects from the family Cecidomyiidae or the family Tephritidae comprising treating a plant or plant part infected with an insect from the family Cecidomyiidae or the family Tephritidae with a compound of formula (I-4) 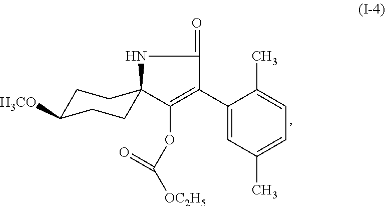
in the form of its pure cis-isomer, to thereby control the insects.

2. The method according to claim 1, wherein the insects are from the family Cecidomyiidae.

3. The method according to claim 2, wherein the insects are Contarinia spp., Dasineura spp., or Diplosis spp.

4. The method according to claim 2, wherein the insects are Dasineura mali or Dasineura pyri.

5. The method according to claim 2, wherein the plant infected with an insect is an apple or pear tree.

6. The method according to claim 2, wherein the application rate of the compound of formula (I-4) is 72 to 150 grams a.s./ha/m crown level.

7. The method according to claim 1, wherein the insects are from the family Tephritidae.

8. The method according to claim 7, wherein the insects are Anastrepha spp., Ceratitis spp., Dacus spp., or Rhagoletis spp.

9. The method according to claim 7, wherein the insects are Ceratitis capitata, Rhagoletis cerasi, Dacus ciliatus, or Dacus oleae.

10. The method according to claim 7, wherein the plant infected with an insect is a peach tree, cherry tree, bottle gourd, or olive.

11. The method according to claim 7, wherein the application rate of the compound of formula (I-4) is 75 to 200 grams a.s./ha.

12. The method according to claim 1, wherein the plant infected with an insect is citrus, pome fruit, stone fruit, vegetables, cereals, potatoes, alfalfa, cotton, spices, or soft fruit.

13. The method according to claim 1, wherein the compound of formula (I-4) is present in a composition in the range of 0.0001 to 1% by weight.
